(19) United States
(12) Patent Application Publication
(10) Pub. No.: US 2018/0179075 A1
(43) Pub. Date: Jun. 28, 2018

(54) APPARATUS AND METHOD FOR MANUFACTURING AEROGEL SHEET

(71) Applicant: LG CHEM, LTD., Seoul (KR)

(72) Inventors: Ye Hon KIM, Daejeon (KR); Je Kyun LEE, Daejeon (KR); Kyoung Shil OH, Daejeon (KR)

(21) Appl. No.: 15/738,516

(22) PCT Filed: Feb. 7, 2017
(86) PCT No.: PCT/KR2017/001325

§ 371 Date: Dec. 20, 2017

(30) Foreign Application Priority Data
Feb. 19, 2016 (KR) 10-2016-0019830

(51) Int. Cl. C01B 33/158; C01B 33/145; C01B 33/155; B05C 5/02; B05C 9/12; B05C 11/02; B05D 1/26; B05D 3/02

(52) U.S. Cl. CPC C01B 33/1585; C01B 33/145; C01B 33/155; B05C 5/0245; B65H 37/00; B05C 11/028; B05D 1/26; B05D 3/0254; C01P 2006/32; B05C 9/12

(57) ABSTRACT

The present invention relates to a method for manufacturing an aerogel sheet and comprises: a step (a) of preparing silica sol and a surface modifying agent to prepare a silica precursor; a step (b) of preparing a gelling catalyst; a step (c) of injecting the silica precursor prepared in the step (a) to a surface of a blanket to impregnate the silica precursor; and a step (d) of injecting the gelling catalyst prepared in the step (b) to the surface of the blanket in which the silica precursor is impregnated to gelate the silica precursor.

### CROSS-REFERENCE TO RELATED APPLICATION

The present application claims the benefit of the priority of Korean Patent Application No. 10-2016-0019830, filed on Feb. 19, 2016, which is hereby incorporated by reference in its entirety.

### TECHNICAL FIELD

The present invention relates to an apparatus and method for manufacturing an aerogel sheet, and more particularly, to an apparatus and method for manufacturing an aerogel sheet having excellent thermal insulation and durability and a uniform thickness.

### BACKGROUND ART

In general, aerogel is a high porosity material having high porosity of about 90% to about 99% in solids that are known up to date. A silica precursor solution is subjected to sol-gel polymerization reaction to prepare gel, and then, a drying process is performed on the prepared gel under supercritical or atmospheric conditions to obtain the aerogel. That is, the aerogel has a pore structure filled with air.

Such the aerogel is lightweight and has physical properties such as heat insulation and sound absorption due to the unique pore structure in which 90% to 99% of an internal space is empty. The greatest advantage of the above-described advantages is the high heat insulation having thermal conductivity of 30 mW/m·k or less, which is significantly lower than thermal conductivity of 36 mW/m·k that is thermal conductivity of an organic insulation material such as conventional Styrofoam and the like.

### DISCLOSURE OF THE INVENTION

### Technical Problem

There are problems that the aerogel sheet according to the related art has a nonuniform thickness and poor heat insulation and durability.

The present invention has been made to solve the abovementioned problems, and an object of the prevent invention is to provide an apparatus and method for manufacturing an aerogel sheet having excellent heat insulation and durability and a uniform thickness.

### Technical Solution

To achieve the above-described object, a method for manufacturing an aerogel sheet according to the present invention comprises: a step (a) of preparing silica sol and a surface modifying agent to prepare a silica precursor; a step (b) of preparing a gelling catalyst; a step (c) of injecting the silica precursor prepared in the step (a) to a surface of a blanket to impregnate the silica precursor; and a step (d) of injecting the gelling catalyst prepared in the step (b) to the surface of the blanket in which the silica precursor is impregnated to gelate the silica precursor.

In the step (a), tetraethyl orthosilicate (TEOS) and ethanol may be mixed to prepare the silica sol.

The tetraethyl orthosilicate (TEOS) may comprise hydrolyzed TEOS.

In the step (a), the surface modifying agent may comprise hexamethyldisilazane (HMDS).

In the step (b), ethanol and ammonia water (NH₄OH) may be mixed to prepare the gelling catalyst.

The step (c) and the step (d) may be performed within a conveyor belt that transfers the blanket from one side to the other side thereof.

The conveyor belt may comprise a scraper comprising a first scraper adjusting a thickness of the silica precursor injected to the surface of the blanket and a second scraper adjusting a thickness of the gelling catalyst injected to the surface of the blanket.

In the step (d), the gelling catalyst may be injected to the surface of the blanket at a rate of 0.035 L/min to 0.012 L/min to leave the gelling catalyst for a time of 8 minutes to 12 minutes and thereby to gelate the silica precursor.

After the step (d), the method may further comprise a step (e) of aging the blanket in which the silica precursor is gelated.

In the step (e), the blanket in which the silica precursor is gelated may be aged for 50 minutes at a temperature of 70° C.

After the step (e), the method may further comprise a step (f) of drying the blanket in which the aging is completed.

The step (f) may comprise a first drying step of injecting carbon dioxide at a rate of 70 L/min for ten minutes under environments of a temperature of 28° C. and a pressure of 70 bar to dry the aged blanket, a second drying step of raising up to a temperature of 50° C. for 1 hour and 20 minutes to dry the blanket, a third drying step of injecting carbon dioxide at a rate of 0.7 L/min for 20 minutes under a temperature of 50° C. and a pressure of 150 bar to dry the blanket again, and a fourth drying step of injecting carbon dioxide at a rate of 0.7 L/min for 20 minutes after breaking for 20 minutes to dry the blanket.

In the third drying step of the step (f), the ethanol generated from the blanket may be collected while drying the blanket.

The step (f) may further comprise a step of discharging the carbon dioxide for 2 hours after the fourth drying step.

The steps (e) and (f) may be performed in a reaction container accommodating the blanket.

In the step (f), supercritical drying may be performed in a state in which the blanket is accommodated in the reaction container.

An apparatus for performing the method for manufacturing the aerogel sheet comprises: a supply roller around which a blanket is wound in the form of a roll; a conveyor belt transferring the blanket wound around the supply roller from one side to the other side thereof; a silica precursor supply member injecting a silica precursor to a surface of the blanket disposed on the conveyor belt to impregnate the silica precursor; a catalyst supply member injecting a gelling catalyst to surface of the blanket disposed on the conveyor belt to gelate the silica precursor; a collection roller winding the blanket, which is transferred up to the outer side by the conveyor belt, in the form of the roll to collect the blanket; and a reaction container which accommodates the roll-shaped blanket collected by the collection roller and in which the accommodated blanket is aged and dried at a high temperature, wherein the silica precursor comprises silica sol and a surface modifying agent.

### Advantageous Effects

The present invention has effects as follows.

First: the present invention may use the method for manufacturing the aerogel sheet to manufacture the aerogel sheet having the superior insulation and durability, particularly, having the uniform thickness.

Second: in the method for manufacturing the aerogel according to the present invention, the silica sol and the surface modifying agent may be mixed to prepare the silica sol precursor, thereby improving the work efficiency.

Third: in the method for manufacturing the aerogel sheet according to the present invention, the tetraethyl orthosilicate (TEOS) and the ethanol may be mixed to obtain the silica sol having the high quality.

Fourth: in the method for manufacturing the aerogel sheet according to the present invention, the hydrolyzed TEOS may be used to obtain the silica sol having the high quality.

Fifth: in the method for manufacturing the aerogel sheet according to the present invention, the ethanol and the ammonia water (NH₄OH) may be mixed to obtain the gelling catalyst having the high quality.

Sixth: in the method for manufacturing the aerogel sheet according to the present invention, the conveyor belt for transferring the blanket from one side to the other side thereof may be used to achieve the continuity of the operation and the simplification of the process.

Seventh: in the method for manufacturing the aerogel sheet according to the present invention, the scraper may be provided on the conveyor belt to uniformly adjust the thickness of the silica sol or the gelling catalyst.

Eighth: in the method for manufacturing the aerogel sheet according to the present invention, the blanket in which the silica sol is gelated may be aged and dried to obtain the aerogel sheet having the high quality.

### BRIEF DESCRIPTION OF THE DRAWINGS

FIG. 1 is a flowchart illustrating a method for manufacturing an aerogel sheet according to the present invention.

FIG. 2 is a view illustrating an apparatus of manufacturing the aerogel sheet according to the present invention.

FIG. 3 is a view of a reaction container provided in the apparatus for manufacturing the aerogel sheet according to the present invention.

### MODE FOR CARRYING OUT THE INVENTION

Hereinafter, embodiments of the present invention will be described in detail with reference to the accompanying drawings in such a manner that the technical idea of the present invention may easily be carried out by a person with ordinary skill in the art to which the invention pertains. The present invention may, however, be embodied in different forms and should not be construed as limited to the embodiments set forth herein. In the drawings, anything unnecessary for describing the present invention will be omitted for clarity, and also like reference numerals in the drawings denote like elements.

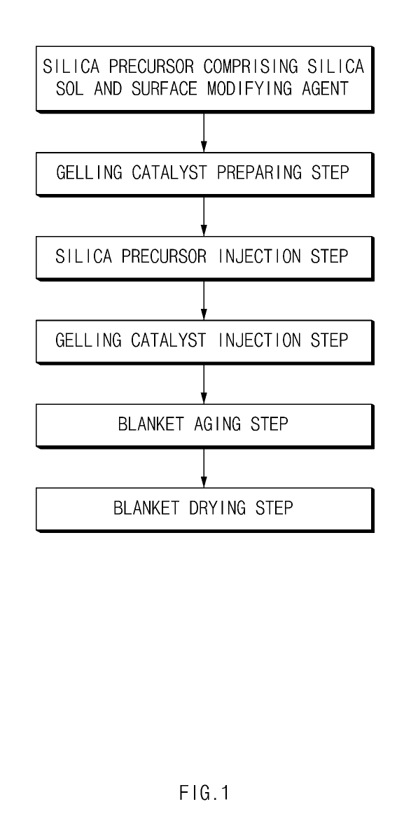

A method for manufacturing an aerogel sheet according to the present invention comprises, as illustrated in FIG. 1, a silica precursor preparing step (a) of preparing a silica precursor, a gelling catalyst preparing step (b) of preparing a gelling catalyst, a silica precursor injection step (c) of injecting the silica precursor to a surface of a blanket to impregnate the silica precursor, a catalyst injection step (d) of injecting the gelling catalyst to the surface of the blanket, into which the silica precursor is impregnated, to gelate the silica precursor, a blanket aging step (e) of aging the blanket in which the silica precursor is gelated, and a blanket drying step (f) of drying the aged blanket.

Hereinafter, the method for manufacturing the aerogel sheet according to the present invention will be described in more detail.

(a) Silica Precursor Preparing Step

The silica precursor preparing step is a step of obtaining a silica precursor. Here, silica sol and a surface modifying agent are mixed to prepare a silica precursor 20.

The present invention may have a technical feature in which the silica sol and the surface modifying agent are mixed to prepare the silica precursor 20, and the prepared silica precursor 20 is impregnated into a blanket 10 to impregnate the silica sol into a surface of the blanket 10 and simultaneously modify the surface of the blanket 10, thereby improving work efficiency and quality of the aerogel sheet.

Here, the silica sol may be prepared by mixing tetraethyl orthosilicate (TEOS) with ethanol. That is, 1.2 kg of TEOS and 2.7 kg of ethanol are provided in a reaction bath (not shown) to prepare the silica sol.

The TEOS may use a solvent having high reactivity with water and be hydrolyzed to more improve reactivity. That is, the hydrolyzed TEOS and the ethanol may be mixed to obtain the silica sol having excellent reactivity.

Also, hexamethyldisilazane (HMDS) may be used as the surface modifying agent. Here, the HMDS is used to change the surface of the blanket to hydrophobicity. That is, in the silica precursor preparing step (a), 40 kg/m³ of the silica sol and 83.5 g of the surface modifying agent are mixed to prepare the silica precursor 20. Here, a mixing ratio of the silica sol and the surface modifying agent may be merely an example and thus may vary according to its application.

(b) Gelling Catalyst Preparing Step

The gelling catalyst preparing step (b) is a step of obtaining the gelling catalyst. Here, ethanol and ammonia water (NH₄OH) are mixed to prepare the gelling catalyst. That is, 0.5 kg of ethanol and 30 ml of ammonia water (NH₄OH) are mixed in the reaction bath (not shown) to prepare the gelling catalyst.

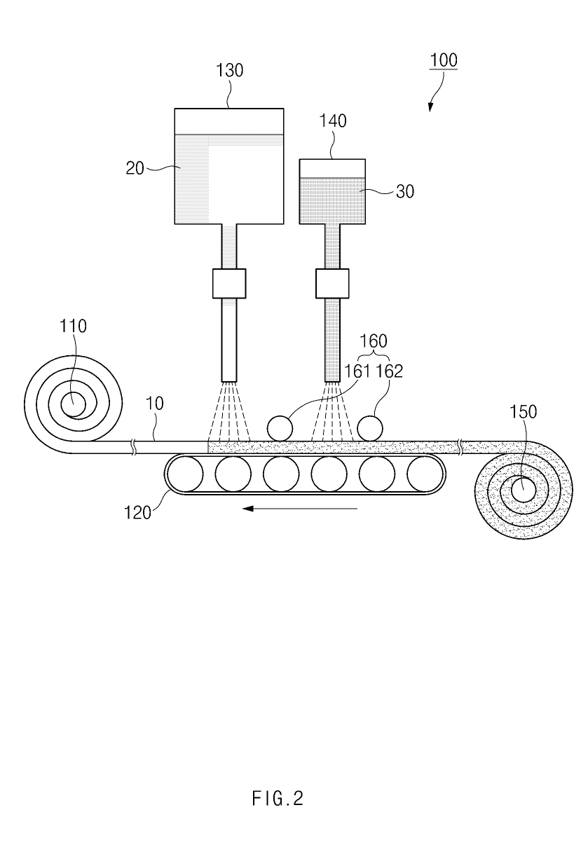

FIG. 2 is a view illustrating an apparatus 100 for manufacturing the aerogel sheet, in which the silica precursor injection step (c) and the gelling catalyst injection step (d) according to the present invention are performed.

That is, as illustrated in FIG. 2, the apparatus 100 for manufacturing the aerogel sheet comprises a supply roller 110 around which the blanket 10 is wound in the form of a roll, a conveyor belt 120 for transferring the blanket 10 wound around the supply roller 110 from one side to the other side thereof, a silica precursor supply member 130 for injecting the silica precursor 20 prepared in the step (a) into a surface of the blanket 10 disposed on the conveyor belt 120 to impregnate the silica precursor 20, a catalyst supply member 140 for injecting the gelling catalyst 30 prepared in the step (b) into the surface of the blanket 10 disposed on the conveyor belt 120 to gelate the silica precursor 20, and a collection roller 150 for winding the blanket 10, which is transferred up to the other side by the conveyor belt 120, in the form of the roll to collect the blanket 10.

In the apparatus 100 for manufacturing the aerogel sheet, when the supply roller 110 supplies the wound blanket 10, the conveyor belt 120 transfers the blanket 10 supplied by the supply roller 110 from one side to the other side thereof, and then, the collection roller 150 winds the blanket 10 again to collect the blanket 10. Here, the silica precursor supply member 130 injects the silica precursor 20 prepared in the step (a) to the surface of the blanket 10 transferred by the conveyor belt 120 to impregnate the silica precursor. Also, the catalyst supply member 140 injects the gelling catalyst 30 to the surface of the blanket 10 in which the silica precursor is impregnated to gelate the silica precursor.

Here, a scraper 160 for uniformly adjusting a thickness of each of the silica precursor 20 and the gelling catalyst 30, which are injected to the blanket 10, may be provided on the conveyor belt 120. That is, the scraper 160 comprises a first scraper 161 for adjusting a thickness of the silica precursor 20 injected to the surface of the blanket 10 and a second scraper 162 for adjusting a thickness of the gelling catalyst 30 injected to the surface of the blanket 10.

That is, the first scraper 161 and the second scraper 162 may have the same shape and be installed to be adjustable in height on a top surface of the conveyor belt 120 to uniformly adjust the thickness of each of the silica precursor 20 and the gelling catalyst 30.

Hereinafter, the silica precursor injection step (c) and the gelling catalyst injection step (d) using the apparatus 100 for manufacturing the aerogel sheet will be described in detail.

(c) Silica Precursor Injection Step

In the silica precursor injection step (c), the silica precursor 20 prepared in the step (a) is injected and impregnated to the surface of the blanket. That is, the silica precursor 20 prepared in the step (a) is injected into and stored in the silica precursor supply member 130. Then, when the blanket 10 is transferred up to a lower side of the silica precursor supply member 130 by the conveyor belt 120, the silica precursor 20 is injected through the silica precursor supply member 130 and impregnated into the surface of the blanket 10.

Here, the silica precursor 20 injected to the blanket 10 may have a uniform thickness while passing through the first scraper 161 installed on the conveyor belt 120. That is, the first scraper 161 may uniformly adjust the thickness of the silica precursor 20 by blocking the silica precursor having a predetermined thickness or more so that the silica precursor 20 does not pass.

(d) Gelling Catalyst Injection Step

In the gelling catalyst injection step (d), the gelling catalyst 30 is injected to the surface of the blanket 10 in which the silica precursor is impregnated in the step (c) to gelate the silica precursor. That is, the gelling catalyst 30 prepared in the step (b) is injected into and stored in the catalyst supply member 140. Then, when the blanket 10 into which the silica precursor is impregnated is transferred up to a lower side of the catalyst supply member 140 by the conveyor belt 120, the gelling catalyst 30 is injected to the surface of the blanket 10 through the catalyst supply member 140 to gelate the silica precursor.

Here, the catalyst supply member 140 may inject the stored gelling catalyst at a preset rate and then leave the gelling catalyst 30 for a preset time to stably gelate the silica precursor. That is, the catalyst supply member 140 may inject the gelling catalyst 30 to the surface of the blanket 10 at a rate of 0.035 L/min to 0.012 L/min and then leave the gelling catalyst 30 for 8 minutes to 12 minutes to gradually gelate the silica precursor.

Particularly, the catalyst supply member 140 may uniformly adjust the gelation of the silica precursor by varying the injection rate of the gelling catalyst 30 according to density of the silica precursor 20 impregnated in the blanket 10.

The blanket 10 in which the silica precursor is gelated is wound and collected in the form of the roll by the collection roller 150, and the aging step and the drying step are performed on the collected blanket 10 to complete the aerogel sheet. Here, a reaction container 170 is used.

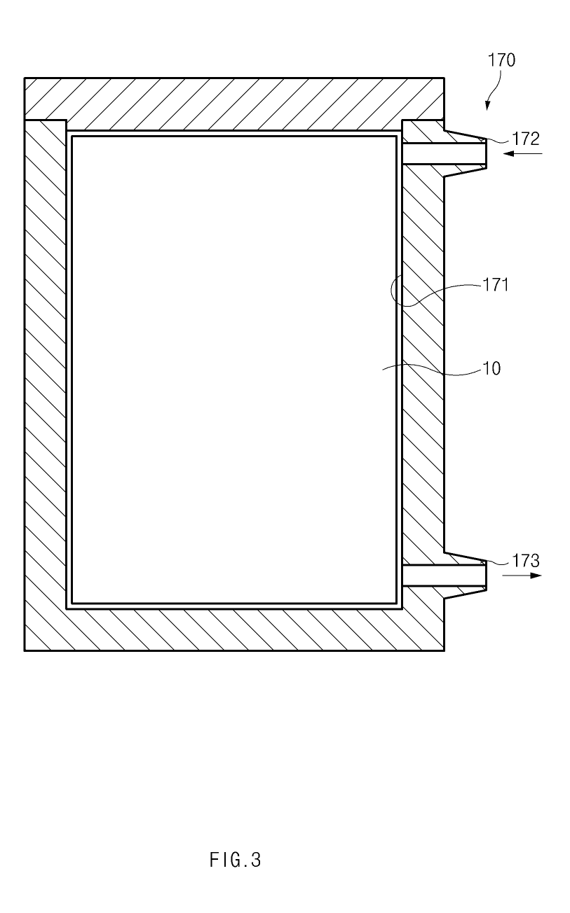

FIG. 3 is a view of the reaction container 170 according to the present invention.

That is, the reaction container 170 has an accommodation space 171 in which the blanket 10 collected in the form of the roll is accommodated. Also, the reaction container 170 has one end in which an injection hole 171 connected to the accommodation space is formed and the other end in which a discharge hole 173 connected to the accommodation space 171 is formed.

Hereinafter, the blanket aging step (e) and the blanket drying step (f) using the reaction container 170 will be described.

(e) Blanket Aging Step

The blanket aging step (e) is a step of aging the blanket in which the silica precursor is gelated. Here, the blanket 10 collected in the step (d) is accommodated in the accommodation space 171 of the reaction container 170, and then, the blanket 10 is aged for 50 minutes while heating the accommodation space 171 of the reaction container 170 up to a temperature of 70° C. to uniformize tissues of the blanket 10.

Here, in the blanket aging step (e), the blanket is left at room temperature (or a temperature of 25° C.) for 10 minutes before being aged in the reaction container 170 to perform the aging on the blanket. That is, the aging for inducing the stable gelation of the silica precursor may be performed to more uniformize the tissues of the blanket.

(f) Blanket Drying Step

In the blanket drying step (f), the aged blanket 10 is dried to complete a silica gel sheet. Here, in the blanket drying step (f), supercritical drying is performed in a state in which the blanket 10 is accommodated in the reaction container 170. That is, the blanket drying step (f) comprises a first drying step of injecting carbon dioxide at a rate of 70 L/min for ten minutes under environments of a temperature of 28° C. and a pressure of 70 bar to dry the blanket 10 of which the surface is modified, a second drying step of raising to a temperature of 50° C. for 1 hour and 20 minutes to dry the blanket 10, a third drying step of injecting carbon dioxide at a rate of 0.7 L/min for 20 minutes again under a temperature of 50° C. and a pressure of 150 bar to dry the blanket 10, and a fourth drying step of injecting carbon dioxide at a rate of 0.7 L/min for 20 minutes after breaking for 20 minutes to dry the blanket 10. The above-described drying steps may be performed to increase a drying rate of the blanket 10.

In the third drying step of the blanket drying step (f), ethanol is generated in the reaction container 170 by chemical reaction between the carbon dioxide and the blanket 10, and the ethanol generated in the reaction container 170 is discharged through the discharge hole 173 and then is collected.

Also, the blanket drying step (f) comprises a discharging step of discharging the carbon dioxide for 2 hours after the fourth drying step. Thus, a gradual environmental change is induced in the blanket 10 to uniformize the tissues of the blanket 10.

The aerogel sheet may be manufactured through the method for manufacturing the aerogel sheet according to the present invention to uniformize the tissues of the blanket and improve insulation and durability of the aerogel sheet.

Accordingly, the scope of the present invention is defined by the appended claims rather than the foregoing description and the exemplary embodiments described therein. Various modifications made within the meaning of an equivalent of the claims of the invention and within the claims are to be regarded to be in the scope of the present invention.

1. A method for manufacturing an aerogel sheet, the method comprising:
a step (a) of preparing silica sol and a surface modifying agent to prepare a silica precursor;
a step (b) of preparing a gelling catalyst;
a step (c) of injecting the silica precursor prepared in the step (a) to a surface of a blanket to impregnate the silica precursor; and
a step (d) of injecting the gelling catalyst prepared in the step (b) to the surface of the blanket in which the silica precursor is impregnated to gelate the silica precursor.

2. The method of claim 1, wherein, in the step (a), tetraethyl orthosilicate (TEOS) and ethanol are mixed to prepare the silica sol.

3. The method of claim 2, wherein the tetraethyl orthosilicate (TEOS) comprises hydrolyzed TEOS.

4. The method of claim 1, wherein, in the step (a), the surface modifying agent comprises hexamethyldisilazane (HMDS).

5. The method of claim 1, wherein, in the step (b), ethanol and ammonia water (NH₄OH) are mixed to prepare the gelling catalyst.

6. The method of claim 1, wherein the step (c) and the step (d) are performed within a conveyor belt that transfers the blanket from one side to the other side thereof.

7. The method of claim 6, wherein the conveyor belt comprises a scraper comprising a first scraper adjusting a thickness of the silica precursor injected to the surface of the blanket and a second scraper adjusting a thickness of the gelling catalyst injected to the surface of the blanket.

8. The method of claim 1, wherein, in the step (d), the gelling catalyst is injected to the surface of the blanket at a rate of 0.035 L/min to 0.012 L/min to leave the gelling catalyst for a time of 8 minutes to 12 minutes and thereby to gelate the silica precursor.

9. The method of claim 1, after the step (d), further comprising a step (e) of aging the blanket in which the silica precursor is gelated.

10. The method of claim 9, wherein, in the step (e), the blanket in which the silica precursor is gelated is aged for 50 minutes at a temperature of 70° C.

11. The method of claim 9, after the step (e), further comprising a step (f) of drying the blanket in which the aging is completed.

12. The method of claim 11, wherein the step (f) comprises a first drying step of injecting carbon dioxide at a rate of 70 L/min for ten minutes under environments of a temperature of 28° C. and a pressure of 70 bar to dry the aged blanket, a second drying step of raising up to a temperature of 50° C. for 1 hour and 20 minutes to dry the blanket, a third drying step of injecting carbon dioxide at a rate of 0.7 L/min for 20 minutes under a temperature of 50° C. and a pressure of 150 bar to dry the blanket again, and a fourth drying step of injecting carbon dioxide at a rate of 0.7 L/min for 20 minutes after breaking for 20 minutes to dry the blanket.

13. The method of claim 12, wherein, in the third drying step of the step (f), the ethanol generated from the blanket is collected while drying the blanket.

14. The method of claim 12, wherein the step (f) further comprises a step of discharging the carbon dioxide for 2 hours after the fourth drying step.

15. The method of claim 12, wherein the steps (e) and (f) are performed in a reaction container accommodating the blanket.

16. The method of claim 12, wherein, in the step (f), supercritical drying is performed in a state in which the blanket is accommodated in the reaction container.

17. An apparatus of manufacturing an aerogel sheet, the apparatus comprising:
a supply roller around which a blanket is wound in the form of a roll;
a conveyor belt transferring the blanket wound around the supply roller from one side to the other side thereof;
a silica precursor supply member injecting a silica precursor to a surface of the blanket disposed on the conveyor belt to impregnate the silica precursor;
a catalyst supply member injecting a gelling catalyst to surface of the blanket disposed on the conveyor belt to gelate the silica precursor;
a collection roller winding the blanket, which is transferred up to the outer side by the conveyor belt, in the form of the roll to collect the blanket; and
a reaction container which accommodates the roll-shaped blanket collected by the collection roller and in which the accommodated blanket is aged and dried at a high temperature,
wherein the silica precursor comprises silica sol and a surface modifying agent.
